(19) United States
(12) Patent Application Publication
(10) Pub. No.: US 2026/0050155 A1
(43) Pub. Date: Feb. 19, 2026

(54) FABRY-PEROT INTERFEROMETER MIRROR DESIGN AND METHOD OF ASSEMBLY

(71) Applicant: Hinalea Imaging Corp., Emeryville, CA (US)

(72) Inventor: Sergey Etchin, Beverly Hills, CA (US)

(21) Appl. No.: 19/291,138

(22) Filed: Aug. 5, 2025

Related U.S. Application Data
(60) Provisional application No. 63/684,771, filed on Aug. 19, 2024.

(51) Int. Cl. G02B 26/08; G01J 3/26

(52) U.S. Cl. CPC G02B 26/0858; G01J 3/26

(57) ABSTRACT

A system includes a top mirror, a bottom mirror, a top spacer mesa, a bottom spacer mesa, and an adhesive. The top mirror is added to a top substrate. The bottom mirror is added to a bottom substrate. The top spacer mesa is added to the top substrate. The bottom spacer mesa is added to the bottom substrate. The adhesive is affixed between a) the top substrate or a top support element and b) the bottom substrate or a bottom support element or a piezo actuator.

### CROSS REFERENCE TO OTHER APPLICATIONS

This application claims priority to U.S. Provisional Patent Application No. 63/684,771 entitled FABRY-PEROT INTERFEROMETER MIRROR DESIGN AND METHOD OF ASSEMBLY filed Aug. 19, 2024 which is incorporated herein by reference for all purposes.

### BACKGROUND OF THE INVENTION

Fabry-Perot variable etalon interferometers (FPIs) are comprised of two parallel mirrors which can move with respect to one another and utilize the interference of light passing through partially transmissive mirrors to select or filter specific wavelength bands from broadband sources. FPIs are useful in measuring spectral content of light passing through the FPIs.

The current FPI assembly process involves active alignment of two mirror plates to where parallelism is achieved and an initial gap between mirrors is set. Consequently, during assembly epoxy is applied and cured with UV light or heat. The final gap dimension and parallelism between mirrors depends on an empirically determined shrink rate of the epoxy during cure. This method is inherently unreliable as the dimension and parallelism of the final gap depends on epoxy shrink rate during cure which in turn depends on many factors like such as the quantity of epoxy applied, epoxy shelf life, etc. Therefore, a consistently repeatable gap cannot be achieved in practice. This leads to a low yield of good devices.

### BRIEF DESCRIPTION OF THE DRAWINGS

Various embodiments of the invention are disclosed in the following detailed description and the accompanying drawings.

FIG. 1 is a diagram illustrating an embodiment of a prior art fixed gap FPI before and after adhesive cure.

FIG. 2 is a diagram illustrating an embodiment of a FPI before and after adhesive cure.

FIG. 3 is a diagram illustrating an embodiment of a prior art variable gap (piezo actuator controlled) FPI before and after adhesive cure.

FIG. 4 is a diagram illustrating an embodiment of a FPI before and after adhesive cure.

FIG. 5 is a diagram illustrating an embodiment of a FPI.

FIG. 6 is a diagram illustrating an embodiment of a FPI.

FIG. 7 is a flow diagram illustrating a process for fabricating an FPI.

FIG. 8 is a flow diagram illustrating a process for fabricating an FPI.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A Fabry-Perot interferometer (FPI) mirror design and method of assembly is disclosed. The FPI includes a top mirror, a bottom mirror, a top spacer mesa, a bottom spacer mesa, and an adhesive. The top mirror is added to a top substrate. The bottom mirror is added to a bottom substrate. The top spacer mesa is added to the top substrate. The bottom spacer mesa is added to the bottom substrate. The adhesive is affixed between a) the top substrate or a top support element and b) the bottom substrate or a bottom support element or a piezo actuator.

In some embodiments, during production one or more specific elements are added to the FPI to establish a minimum gap distance between a top mirror and a bottom mirror. In some embodiments, the one or more specific elements are added using precise production processes (e.g., semiconductor manufacturing processes) such that a repeatable and parallel initial gap is established for the FPI. In some embodiments, the one or more elements comprise one or more mesas on the top substrate supporting the top mirror of an FPI, on the bottom substrate supporting the bottom mirror of the FPI, or on the top substrate and the bottom substrate supporting the top mirror and the bottom mirror, respectively, of the FPI.

In some embodiments, adding the top mirror and the bottom mirror comprises depositing a metal on the top substrate. In various embodiments, the metal comprises one of the following: aluminum, silver, gold, chromium, or any other appropriate metal. In various embodiments, adding or depositing the metal comprises one of the following: physical vapor deposition (PVD), e-beam evaporation deposition, sputtering deposition, or any other appropriate depositing manner.

In some embodiments, adding the top mirror and the bottom mirror comprises adding a dielectric mirror. In some embodiments, adding the top mirror and the bottom mirror comprises adding a dielectric mirror. In some embodiments, the dielectric mirror comprises alternating high index layers and low index layers. In various embodiments, the alternating high index layers and the low index layers comprise a) TiO2 and SiO2, b) GaAs and AlAs, or any other appropriate materials. In various embodiments, adding the dielectric mirror comprises one of the following: molecular beam epitaxy (MBE), metalorganic chemical vapor deposition (MOCVD), sputtering, or any other appropriate manner of adding the mirror.

In some embodiments, the system includes a top position feedback electrode. In some embodiments, the top position feedback electrode is added to the top substrate. In some embodiments, the top substrate is etched prior to adding the top position feedback electrode.

In some embodiments, the system includes a bottom position feedback electrode. In some embodiments, the bottom position feedback electrode is added to the bottom substrate. In some embodiments, the bottom substrate is etched prior to adding the bottom position feedback electrode.

In some embodiments, the piezo actuator is one of three piezo actuators. In some embodiments, the top spacer mesa is one of three top spacer mesas. In some embodiments, the bottom spacer mesa is one of three bottom spacer mesas.

In some embodiments, the top spacer mesa has a top spacer mesa thickness that is greater than a top mirror thickness of the top mirror. In some embodiments, the bottom spacer mesa has a bottom spacer mesa thickness that is greater than a bottom mirror thickness of the bottom mirror.

In some embodiments, the minimum mirror gap comprises the thickness of the top spacer mesa plus the thickness of the bottom spacer mesa less the thicknesses of the top and bottom mirror.

In some embodiments, the development of FPI based hyperspectral imaging, particularly when multi-band pass modes of operation are utilized, introduces a variety of potential advantages in terms of performance and flexibility such as rapid full frame or area image acquisition, dynamically adjustable band selection high spatial, and spectral resolution parameters that are each independent of one another.

In some embodiments, FPIs configured with the appropriate optics, sensors and signal processing environments are used for non-imaging applications such as point spectroscopy and for measuring material physical properties such as thickness of coatings and surface flatness.

In some embodiments, the disclosed relates to the design of mirror plates and corresponding process of assembly of piezo actuated FPIs primarily used in spectral imaging applications in conjunction with a focal plane array sensor.

In some embodiments, actuation technology other than piezo actuation is used to set the mirror gap (e.g., electrostatic, thermal, electromagnetic, shaped metal alloy, electro thermal, microfluidic, etc.).

In some embodiments, a consistent and repeatable minimum gap is achieved between mirrors by eliminating reliance on variable factors such as the epoxy shrink rate.

In some embodiments, the process of manufacturing mirror plates is modified such that, in addition to deposition of mirror film layers, additional vertical pillars or like structures (spacer mesas) are deposited on the die outside of mirror area using different materials and thickness for the film stack of the pillar. In some embodiments, the process for the mesa deposition is similar to semiconductors and is done using photolithography and sputtering deposition in vacuum chamber. In some embodiments, precision of positioning is submicron of the mesas. In some embodiments, precision of thickness is the same as the precision associated with the mirror manufacturing.

In some embodiments, the number of structures is three, but it does not need to be limited to three and has various shapes (e.g., rectangular cross section, circular cross section, etc.) and arrangements (e.g., in a triangular layout, in a square layout, etc.).

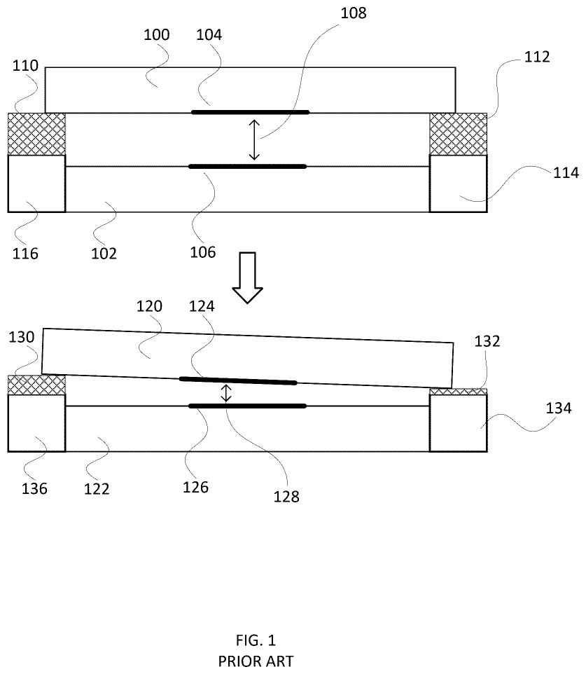

FIG. 1 is a diagram illustrating an embodiment of a prior art fixed gap FPI before and after adhesive cure. In the example shown before curing of the adhesive, top substrate 100 has an added top mirror 104. Bottom substrate 102 has an added bottom mirror 106. Left mirror support 116 and left uncured adhesive 110 support top substrate 100 on the left side of diagram in FIG. 1, and right mirror support 114 and right uncured adhesive 112 support top substrate 100 on the right side of diagram in FIG. 1 to create gap 108 between top mirror 104 and bottom mirror 106.

In the example shown after curing of the adhesive, top substrate 120 has an added top mirror 124. Bottom substrate 122 has an added bottom mirror 126. Left mirror support 136 and left cured adhesive 130 support top substrate 120 on the left side of diagram in FIG. 1, and right mirror support 134 and right cured adhesive 132 support top substrate 120 on the right side of diagram in FIG. 1 to create gap 128 between top mirror 124 and bottom mirror 126. Notice the non-parallel alignment after curing between top mirror 124 and bottom mirror 126 compared to the parallel alignment before curing of the adhesive between top mirror 104 and bottom mirror 106. Also, note that the diagram of FIG. 1 is showing a side view of a three-dimensional device so a misalignment is only shown in two dimensions whereas in the actual device is three-dimensional. In the three-dimensional situation, there are three mirror supports in a triangle configuration each with adhesive to support a top mirror separated from a bottom mirror (e.g., top mirror 104 and top mirror 124 separated from bottom mirror 106 and bottom mirror 126).

In some embodiments, the top level sequence of fabrication for a fixed gap FPI of FIG. 1 is as follows: 1) Top mirror support elements are attached to bottom mirror; 2) Top mirror is placed at a predetermined distance from the bottom mirror; 3) The space between top of mirror support elements and top mirror is filled with adhesive; 4) During the cure process, the adhesive shrinks bringing the top mirror closer to the bottom mirror producing final gap.

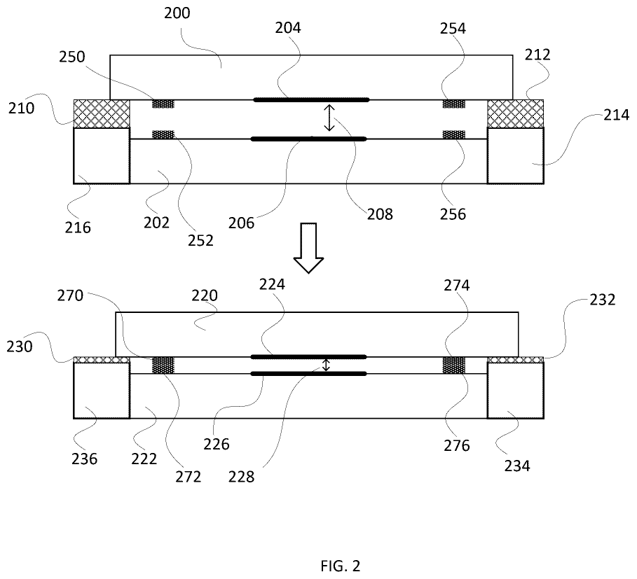

FIG. 2 is a diagram illustrating an embodiment of a FPI before and after adhesive cure. In the example shown before curing of the adhesive, top substrate 200 has an added top mirror 204. Bottom substrate 202 has an added bottom mirror 206. Left mirror support 216 and left uncured adhesive 210 support top substrate 200 on the left side of diagram in FIG. 2, and right mirror support 214 and right uncured adhesive 212 support top substrate 200 on the right side of diagram in FIG. 2 to create a before cure gap 208 between top mirror 204 and bottom mirror 206. Left top spacer mesa 250 is added to top substrate 200 in a position aligned with left bottom spacer mesa 252 that is added to bottom substrate 202. Right top spacer mesa 254 is added to top substrate 200 in a position aligned with right bottom spacer mesa 256 that is added to bottom substrate 202.

In the example shown after curing of the adhesive, top substrate 220 has an added top mirror 224. Bottom substrate 222 has an added bottom mirror 226. Left mirror support 236 and left cured adhesive 230 support top substrate 220 on the left side of diagram in FIG. 2, and right mirror support 234 and right cured adhesive 232 support top substrate 220 on the right side of diagram in FIG. 2 to create gap 228 between top mirror 224 and bottom mirror 226. Left top spacer mesa 270 is added to top substrate 220 in a position aligned with left bottom spacer mesa 272 that is added to bottom substrate 222. Right top spacer mesa 274 is added to top substrate 220 in a position aligned with right bottom spacer mesa 276 that is added to bottom substrate 222. Notice the parallel alignment after curing between top mirror 224 and bottom mirror 226 due to the spacer mesas setting the gap. Also, note that the diagram of FIG. 2 is showing a side view of a three-dimensional device so a alignment is only shown in two dimensions whereas in the actual device is three-dimensional. In the three-dimensional situation, there are three mesa spacer sets that support in a triangle configuration.

In some embodiments, the location of the mesas on the mirror dies are such that when FPI device is assembled such that all three mesas on the bottom mirror align perfectly with mesas on the top mirror. The combined height of the mesas on the bottom mirror and the top mirror determines the minimum gap of the FPI. FIG. 2 comprises a fixed gap Etalon. Note that in FIG. 2, there are no electrodes in the structure.

For the embodiment of FPI with a fixed gap, the mesas are deposited on the same plane as mirror layers.

In some embodiments, the top level sequence of fabrication for a fixed gap FPI of FIG. 2 is as follows: 1) The top mirror support elements are attached to bottom mirror; 2) The top mirror is placed at a predetermined distance from the bottom mirror; 3) The space between the top of mirror support elements and the top mirror is filled with adhesive; 4) During the cure process adhesive shrinks bringing top mirror closer to the bottom mirror; 5) The spacer mesas of the top mirror and the bottom mirror come in contact and stop the motion of top mirror counteracting effects of adhesive shrinkage and providing registration points to produce a parallel and repeatable final gap.

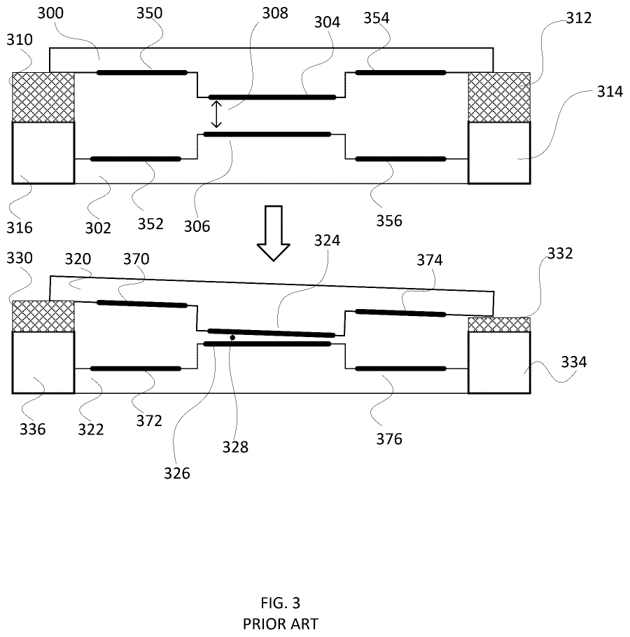

FIG. 3 is a diagram illustrating an embodiment of a prior art variable gap (piezo actuator controlled) FPI before and after adhesive cure. In the example shown before curing of the adhesive, top substrate 300 has an added top mirror 304. Bottom substrate 302 has an added bottom mirror 306. Left piezo actuator 316 and left uncured adhesive 310 support top substrate 300 on the left side of diagram in FIG. 3, and right piezo actuator 314 and right uncured adhesive 312 support top substrate 300 on the right side of diagram in FIG. 3 to create gap 308 between top mirror 304 and bottom mirror 306. Left top sensor electrode 350 is positioned above left bottom sensor electrode 352. Right top sensor electrode 354 is positioned above right bottom sensor electrode 356. Note this is a side view of a three-dimensional device so the sensor electrodes are positioned to measure the tilts in three dimensions.

In the example shown after curing of the adhesive, top substrate 320 has an added top mirror 324. Bottom substrate 322 has an added bottom mirror 326. Left piezo actuator 336 and left cured adhesive 330 support top substrate 320 on the left side of diagram in FIG. 3, and right piezo actuator 334 and right cured adhesive 332 support top substrate 320 on the right side of diagram in FIG. 3 to create gap 328 between top mirror 324 and bottom mirror 326. Notice the non-parallel alignment after curing between top mirror 324 and bottom mirror 326 compared to the parallel alignment before curing of the adhesive between top mirror 304 and bottom mirror 306. Left top sensor electrode 370 is positioned above left bottom sensor electrode 372. Right top sensor electrode 374 is positioned above right bottom sensor electrode 376. Note this is a side view of a three-dimensional device so the sensor electrodes are positioned to measure the tilts in three dimensions. Also, note that the diagram of FIG. 3 is showing a side view of a three-dimensional device, so a misalignment is only shown in two dimensions whereas the actual device is three-dimensional. In the three-dimensional situation, there are three mirror supports in a triangle configuration each with adhesive to support a top mirror separated from a bottom mirror (e.g., top mirror 304 and top mirror 324 separated from bottom mirror 306 and bottom mirror 326).

In some embodiments, the top level sequence of fabrication for a variable gap FPI of FIG. 3 is as follows: 1) Piezo actuators are attached to the bottom mirror; 2) The top mirror is placed at a predetermined distance from the bottom mirror; 3) The space between the top of piezo actuators and top mirror is filled with adhesive; 4) During the cure process the adhesive shrinks bringing top mirror closer to the bottom mirror producing final gap.

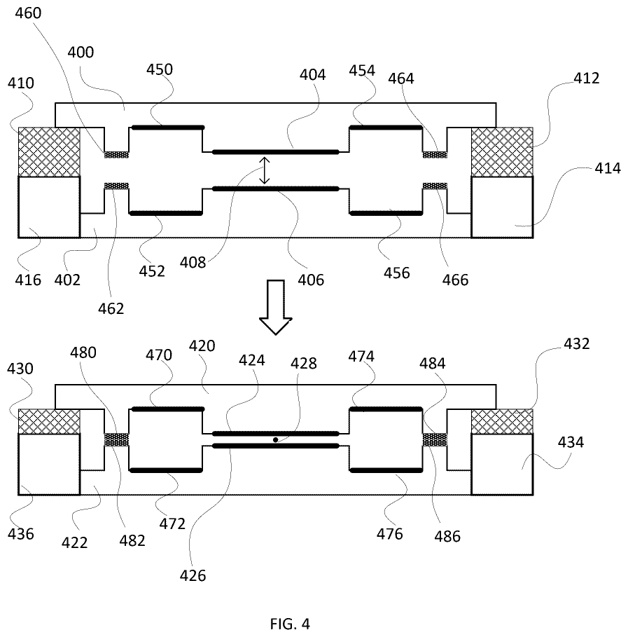

FIG. 4 is a diagram illustrating an embodiment of a FPI before and after adhesive cure. In the example shown before curing of the adhesive, top substrate 400 has an added top mirror 404. Bottom substrate 402 has an added bottom mirror 406. Left piezo actuator 416 and left uncured adhesive 410 support top substrate 400 on the left side of diagram in FIG. 4, and right piezo actuator 414 and right uncured adhesive 412 support top substrate 400 on the right side of diagram in FIG. 4 to create gap 408 between top mirror 404 and bottom mirror 406. Left top sensor electrode 450 is positioned above left bottom sensor electrode 452. Right top sensor electrode 454 is positioned above right bottom sensor electrode 456. Note this is a side view of a three-dimensional device so the sensor electrodes are positioned to measure the tilts in three dimensions. Left top mesa spacer 460 is positioned to align with left bottom mesa spacer 462. Right top mesa spacer 464 is positioned to align with right bottom mesa spacer 466.

In the example shown after curing of the adhesive, top substrate 420 has an added top mirror 424. Bottom substrate 422 has an added bottom mirror 426. Left piezo actuator 436 and left cured adhesive 430 support top substrate 420 on the left side of diagram in FIG. 4, and right piezo actuator 434 and right cured adhesive 432 support top substrate 420 on the right side of diagram in FIG. 4 to create gap 428 between top mirror 424 and bottom mirror 426. Left top sensor electrode 470 is positioned above left bottom sensor electrode 472. Right top sensor electrode 474 is positioned above right bottom sensor electrode 476. Note this is a side view of a three-dimensional device so the sensor electrodes are positioned to measure the tilts in three dimensions. Notice the parallel alignment after curing between top mirror 424 and bottom mirror 426. Also, note that the diagram of FIG. 4 is showing a side view of a three-dimensional device, so an alignment is only shown in two dimensions whereas the actual device is three-dimensional. Left top mesa spacer 480 is positioned to align with left bottom mesa spacer 482. Right top mesa spacer 484 is positioned to align with right bottom mesa spacer 486. In the three-dimensional situation, there are three mirror supports in a triangle configuration each with mesas to support a top mirror separated from a bottom mirror (e.g., top mirror 404 and top mirror 424 separated from bottom mirror 406 and bottom mirror 426).

In some embodiments of the Fabry Perot Interferometer with a piezo controlled variable gap, the first step of the process is to create a mesa for the mirror area by removing some of the die material around the mesa to form an indentation that accommodates one or more capacitive feedback electrodes (e.g., left top sensor electrode, left bottom sensor electrode, right top sensor electrode, and right bottom sensor electrode) that are placed below the surface of the mirror.

In some embodiments of Fabry Perot Interferometer with a piezo controlled variable gap, the spacer mesas are formed at the same time as the mirror mesa and are of the same height. The vertical pillar or like structures (spacers) are deposited on the spacer mesas using materials that are the same or different from mirror film stack and thicknesses different from the mirror film stack. In some embodiments, the material for the spacer structures are selected to avoid any sticking between the top spacer structure and the bottom spacer structure so that there is not any resistance to separating the mirrors from a minimum mirror spacing when the top spacer structure and the bottom spacer structure come into contact with one another.

In some embodiments, the dimension of the minimum gap between mirrors is calculated as a difference between sum of bottom die mesa and top die mesa thicknesses and sum of bottom mirror and top mirror layers thicknesses.

Calculation of the minimum FPI gap distance:

$${D}_{gap} = ( {D}_{s - bot} + {D}_{s - top} ) - ( {D}_{m - bot} + {D}_{m - top} )$$

In the case of equal thickness of layers on both top and bottom mirror dies:

$${D}_{gap} = {( {D}_{s} - {D}_{m - bot} )}^{2}$$

Where:
D_{gap} is FPI min gap dimension
D_{s-bot} is bottom die mesa height
Dₛ₋ₜₒₚ is top die mesa height
D_{m-bot} is Bottom die mirror layers thickness
Dₘ₋ₜₒₚ is Top die mirror layers thickness

For the prior art assembly process, the top mirror is placed above the bottom mirror at pre-determined initial gap. Epoxy is applied to either support structure or piezo actuators. The cure process is then initiated. During the curing period, the epoxy shrinks a finite amount pulling the mirrors together. The final FPI gap is thus set by the initial gap before cure and epoxy shrink rate.

In some embodiments, the disclosed simplified assembly method employs mirror dies with spacer mesas. The top mirror is placed above bottom mirror in such a way that the spacer mesas are aligned and in contact or at some distance from each other. Epoxy is applied to any support structures or piezo actuators. The cure process is initiated. During curing, the epoxy shrinks pulling mirrors together until mesas come in contact. This sets FPI minimum gap.

In some embodiments, the top level sequence of fabrication for a variable gap FPI of FIG. 4 is as follows: 1) The piezo actuators are attached to the bottom mirror; 2) The top mirror is placed at predetermined distance from the bottom mirror; 3) The space between the top of piezo actuators and top mirror is filled with adhesive; 4) During the cure process, the adhesive shrinks bringing the top mirror closer to the bottom mirror; 5) The spacer mesas of the top mirror and the bottom mirror come in contact and stop the motion of top mirror counteracting the effects of adhesive shrinkage and providing registration points to produce parallel and repeatable final gap.

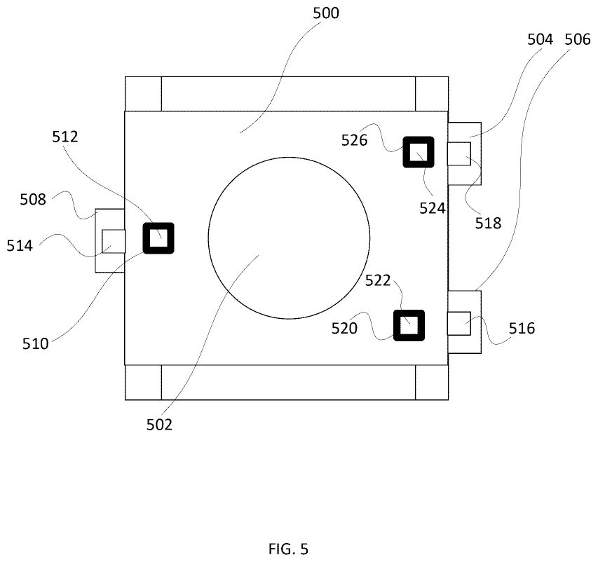

FIG. 5 is a diagram illustrating an embodiment of a FPI. In some embodiments, the FPI of FIG. 5 is a top view of the FPI of FIG. 2. In the example shown, top substrate 500 has FPI aperture 502 with mirror added to bottom side of top substrate 500. Bottom mesa 510, bottom mesa 520, and bottom mesa 526 align with and are in contact with top mesa 512, top mesa 522, and top mesa 524, respectively to set a minimum gap between top substrate 500 and a bottom substrate (underneath top substrate 500). Support structure 508, support structure 504, and support structure 506 with respective adhesive 514, adhesive 518, and adhesive 516 that couple top substrate 500 and bottom substrate.

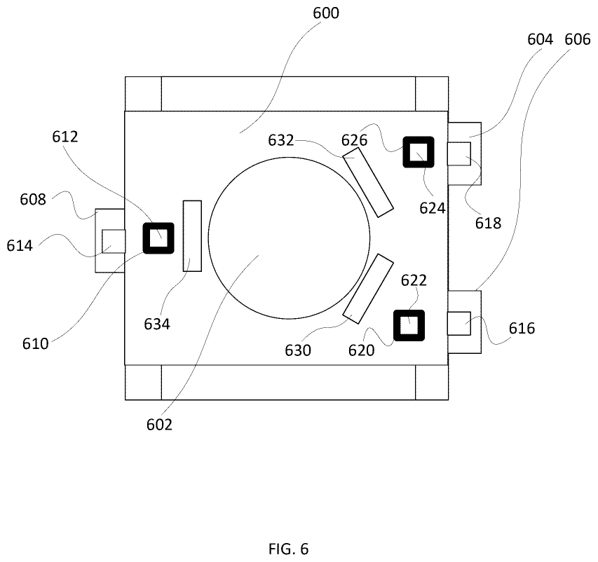

FIG. 6 is a diagram illustrating an embodiment of a FPI. In some embodiments, the FPI of FIG. 6 is a top view of the FPI of FIG. 4. In the example shown, top substrate 600 has FPI aperture 602 with mirror added to bottom side of top substrate 600. Bottom mesa 610, bottom mesa 620, and bottom mesa 626 align with and are in contact with top mesa 612, top mesa 622, and top mesa 624, respectively to set a minimum gap between top substrate 600 and a bottom substrate (underneath top substrate 600). Piezo actuator 608, support piezo actuator 604, and piezo actuator 606 with respective adhesive 614, adhesive 618, and adhesive 616 that couple top substrate 600 and bottom substrate. Sensor electrode 630, sensor electrode 632, and sensor electrode 634 are used to determine position set using piezo actuator 608, support piezo actuator 604, and piezo actuator 606.

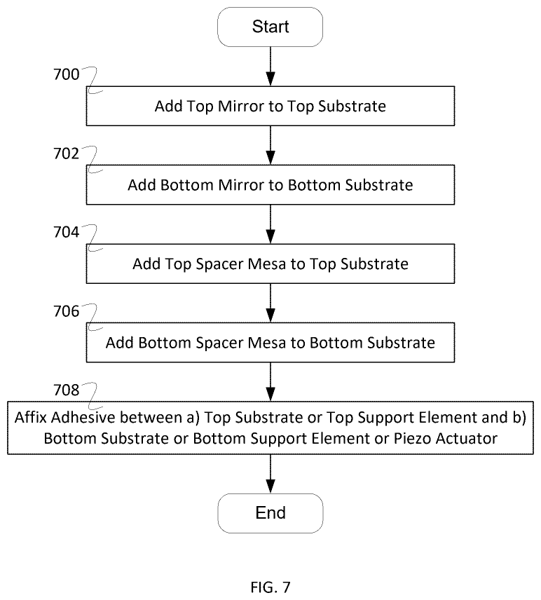

FIG. 7 is a flow diagram illustrating a process for fabricating an FPI. In some embodiments, the process of FIG. 7 is used to fabricate the FPI of FIG. 2 or FIG. 4. In the example shown, in 700 a top mirror is added to a top substrate. In 702, a bottom mirror is added to a bottom substrate. In 704, a top spacer mesa is added to the top substrate. In 706, a bottom spacer mesa is added to the bottom substrate. In 708, adhesive is affixed between a) a top substrate or top support element and b) a bottom substrate or a bottom support element or a piezo actuator.

In some embodiments, the top and bottom are switched so that the adhesive is affixed between a) a bottom substrate or bottom support element and b) a top substrate or a top support element or a piezo actuator.

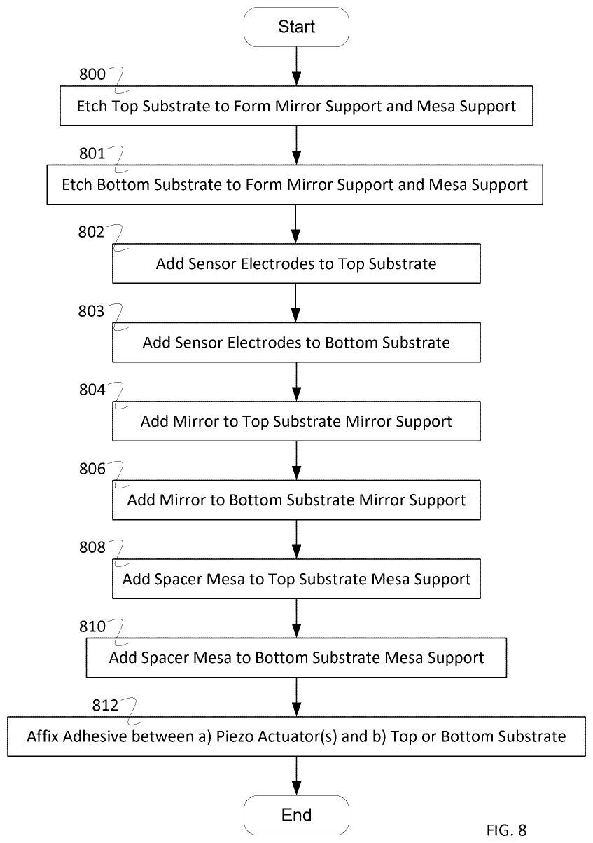

FIG. 8 is a flow diagram illustrating a process for fabricating an FPI. In some embodiments, the process of FIG. 8 is used to fabricate the FPI of FIG. 2 or FIG. 4. In the example shown, in 800 a top substrate is etched to form a mirror support and mesa support. In 801, a bottom substrate is etched to form a mirror support and a mesa support. In 802, sensor electrodes are added to top substrate. For example, top electrodes for position feedback sensors are added to the top substrate in alignment with bottom electrodes. In 803, sensor electrodes are added to bottom substrate. For example, bottom electrodes for position feedback sensors are added to the bottom substrate in alignment with top electrodes. In 804, a top mirror is added to a top substrate mirror support. In 806, a bottom mirror is added to a bottom substrate mirror support. In 808, a top spacer mesa is added to the top substrate mesa support. In 810, a bottom spacer mesa is added to the bottom substrate mesa support. In 812, adhesive is affixed between a) piezo actuator(s) and b) a top substrate or a bottom substrate.

In some embodiments, the top and bottom are switched so that the adhesive is affixed between a) a bottom substrate or bottom support element and b) a top substrate or a top support element or a piezo actuator.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a top mirror, wherein the top mirror is added to a top substrate;
a bottom mirror, wherein the bottom mirror is added to a bottom substrate;
a top spacer mesa, wherein the top spacer mesa is added to the top substrate;
a bottom spacer mesa, wherein the bottom spacer mesa is added to the bottom substrate; and
an adhesive, wherein the adhesive is affixed between a) the top substrate or a top support element and b) the bottom substrate or a bottom support element or a piezo actuator.

2. The system of claim 1, wherein adding the top mirror and the bottom mirror comprises depositing a metal on the top substrate.

3. The system of claim 2, wherein the metal comprises one of the following: aluminum, silver, gold, and chromium.

4. The system of claim 2, wherein depositing the metal comprises one of the following: physical vapor deposition, e-beam evaporation deposition, and sputtering deposition.

5. The system of claim 1, wherein adding the top mirror and the bottom mirror comprises adding a dielectric mirror.

6. The system of claim 5, wherein the dielectric mirror comprises alternating high index layers and low index layers.

7. The system of claim 6, wherein the alternating high index layers and the low index layers comprise a) TiO2 and SiO2 or b) GaAs and AlAs.

8. The system of claim 5, wherein adding the dielectric mirror comprises one of the following: molecular beam epitaxy, metalorganic chemical vapor deposition, and sputtering.

9. The system of claim 1, further comprising a top position feedback electrode.

10. The system of claim 9, wherein the top position feedback electrode is added to the top substrate.

11. The system of claim 9, wherein the top substrate is etched prior to adding the top position feedback electrode.

12. The system of claim 1, further comprising a bottom position feedback electrode.

13. The system of claim 11, wherein the bottom position feedback electrode is added to the bottom substrate.

14. The system of claim 11, wherein the bottom substrate is etched prior to adding the bottom position feedback electrode.

15. The system of claim 1, wherein the piezo actuator is one of three piezo actuators.

16. The system of claim 1, wherein the top spacer mesa is one of three top spacer mesas.

17. The system of claim 1, wherein the bottom spacer mesa is one of three bottom spacer mesas.

18. The system of claim 1, wherein the top spacer mesa has a top spacer mesa thickness that is greater than a top mirror thickness of the top mirror.

19. The system of claim 1, wherein the bottom spacer mesa has a bottom spacer mesa thickness that is greater than a bottom mirror thickness of the bottom mirror.

20. A method, comprising:
adding a top mirror to a top substrate;
adding a bottom mirror to a bottom substrate;
adding a top spacer mesa to the top substrate;
adding a bottom spacer mesa to the bottom substrate; and
affixing an adhesive between a) the top substrate or a top support element and b) the bottom substrate or a bottom support element or a piezo actuator.
